(19) United States
(12) Patent Application Publication
(10) Pub. No.: US 2021/0389885 A1
(43) Pub. Date: Dec. 16, 2021

(54) Fast Recovery For Persistent Memory Region (PMR) of a Data Storage Device

(71) Applicant: Western Digital Technologies, Inc., San Jose, CA (US)

(72) Inventors: Elkana RICHTER, Tene (IL); Shay BENISTY, Beer Sheva (IL); Amir SEGEV, Meiter (IL)

(21) Appl. No.: 16/903,062

(22) Filed: Jun. 16, 2020

(51) Int. Cl. G06F 3/06; G06F 11/14; G06F 11/30

(52) U.S. Cl. CPC G06F 3/0625; G06F 3/0619; G06F 3/064; G06F 11/3062; G06F 3/0659; G06F 3/0673; G06F 11/1489; G06F 3/0653

(57) ABSTRACT

The present disclosure relates to making a PMR of a data storage device available to a host system prior to being fully restored to a pre-power down state. A PMR priority list is provided for storing a list of priority PMR blocks written by the data storage device but not yet read by the host. When at least one block of the priority list are provided to the PMR, it is made available to the host. If the host writes to a block of the PMR after the priority list is provided, but before the PMR is fully restored, these writes are saved to a PMR write log.

### BACKGROUND OF THE DISCLOSURE

### Field of the Disclosure

Embodiments of the present disclosure generally relate to data storage devices having a persistent memory region (PMR), and more particularly, to power-up recovery of a PMR.

### Description of the Related Art

A number of data storage devices are provided with a persistent memory region (PMR) to enable a host system to read or write directly to the data storage device, without the need of overhead required by command queues. Typical PMR implementations include general purpose portions of memory that are made persistent by virtue of power loss protection (e.g., capacitors) that allow an internal cache to be safely transferred to non-volatile memory in the event of a power down of the data storage device. Contents of the PMR may be written to the non-volatile memory on power down, and upon power up reloaded to the PMR to allow the host system to continue operations on the data storage device.

In prior approaches, a PMR is a fast volatile memory that is considered ‘persistent’ because of the protective circuitry that causes the contents of the PMR to be transferred to non-volatile memory upon power down, or in some implementations, entering a low power state. On power up, the PMR empty, containing no previous commands from the host system, and only becomes available to the host system when the PMR is fully restored to its pre-power down state. While the PMR is being restored, it is not available to the host system, causing latency in the data storage device, leaving this resource unused during the restoration process.

What is needed are systems, devices, and methods to reduce latency of PMR availability upon power up of a data storage device, to enable the PMR to become available before it is fully restored to its pre-power down state.

### SUMMARY OF THE DISCLOSURE

The present disclosure relates to making a PMR of a data storage device available to a host system prior to being fully restored to a pre-power down state. A PMR priority list is provided for storing a list of priority PMR blocks written by the data storage device but not yet read by the host. Once all blocks of the priority list are provided to the PMR, it is made available to the host. If the host writes to a block of the PMR after the priority list is provided, but before the PMR is fully restored, these writes are saved to a PMR write log.

In one embodiment, a data storage device is provided that includes one or more memory devices, and a controller comprising a persistent memory region (PMR) comprising one or more blocks, and a PMR HOT table and coupled to the one or more memory devices. In embodiments, the controller is configured to detect a write to a block of the PMR by the data storage device, and store a high priority indicator for the block of the PMR in the PMR HOT table.

In another embodiment, a data storage device is provided that includes one or more memory devices, a non-volatile memory coupled to the PMR for storing data from the PMR when the data storage device is in a low power mode, and a controller comprising a persistent memor region (PMR) comprising one or more blocks, a PMR write log, the controller coupled to the one or more memory devices. In embodiments, the controller is configured to cause the data storage device to exit a low power mode, read data from the non-volatile memory, and cause data written from a host to be stored in the PMR write log before the data storage device is in a powered state.

In another embodiment, a system for storing data is provided, that includes one or more memory devices comprising a non-volatile memory device, and a controller comprising a PMR means, a write log means, a HOT table means configured to store an indicator that the system has written a data element to the PMR means and a host has not read the data element from the PMR means, and a PMRSTS.NRDY bit indicating that the PMR means is not ready, the controller coupled to the one or more memory devices. In embodiments, the controller is configured to cause the system to exit a low power state, and read the indicator from the HOT table means.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic illustration of a computing system, including a host device and a storage device, according to disclosed embodiments.

FIG. 2 is a schematic illustration of a data storage device according to disclosed embodiments.

FIG. 3 is a schematic illustration of a computing system, including a host device and a data storage device, according to disclosed embodiments.

FIG. 4 is a flowchart illustrating a method for utilizing the PMR HOT table, according to disclosed embodiments.

FIG. 5 is a flowchart illustrating a method for the PMR restoration, according to disclosed embodiments.

FIG. 6A is a flowchart illustrating a method for monitoring the host PMR write access, according to disclosed embodiments.

FIG. 6B is a flowchart illustrating a method for monitoring the host PMR read access, according to disclosed embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure relates to making a PMR of a data storage device available to a host system prior to being fully restored to a pre-power down state. A PMR priority list is provided for storing a list of priority PMR blocks written by the data storage device but not yet read by the host. Once all blocks of the priority list are provided to the PMR, it is made available to the host. If the host writes to a block of the PMR after the priority list is provided, but before the PMR is fully restored, these writes are saved to a PMR write log.

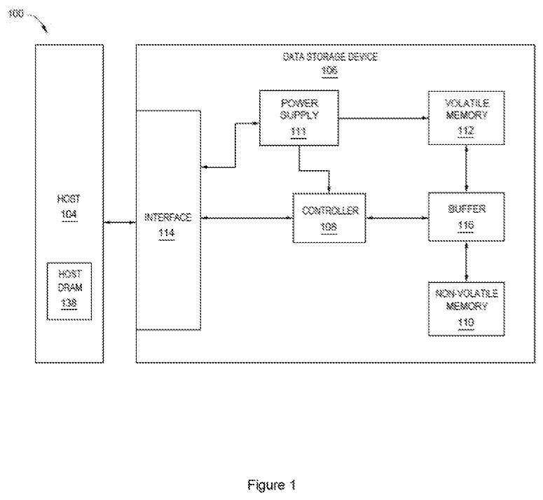

FIG. 1 is a schematic block diagram illustrating a storage system 100 in which data storage device 106 may function as a storage device for a host device 104, in accordance with one or more techniques of this disclosure. For instance, the host device 104 may utilize non-volatile memory devices 110 included in data storage device 106 to store and retrieve data. The host device 104 comprises a host DRAM 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like.

The data storage device 106 includes a controller 108, non-volatile memory (NVM) 110, a power supply 111, volatile memory 112, an interface 114, and a buffer 116. The controller 108 comprises an internal memory or buffer 116. In some examples, the data storage device 106 may include additional components not shown in FIG. 1 for sake of clarity. For example, the data storage device 106 may include a printed board (PB) to which components of the data storage device 106 are mechanically attached and which includes electrically conductive traces that electrically interconnect components of the data storage device 106, or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered) to a motherboard of the host device 104.

The interface 114 of the data storage device 106 may include one or both of a data bus for exchanging data with the host device 104 and a control bus for exchanging commands with the host device 104. The interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like.

The electrical connection of the interface 114 (e.g., the data bus, the control bus, or both) is electrically connected to the controller 108, providing electrical connection between the host device 104 and the controller 108, allowing data to be exchanged between the host device 104 and the controller 108. The interface 114 may be a type of connection unit to transfer data to the data storage device 106 from the host device 104, and vice-versa. Such connection units may be a USB-A connection, a USB-B connection, a mini USB-A connection, a mini USB-B connection, a micro USB-A connection, a micro USB-B connection, a USB-C connection, or a lightning connection. The connection unit may comprise of several pins with a specialized usage. Furthermore, connection units are utilized for various purposes, such as isochronous transfers, interrupt transfers, and bulk transfers. The term “bulk transfers” refers to large sporadic transfers using all remaining available bandwidth, but with no guarantees on bandwidth or latency. Bulk transfers are utilized when transferring files or data through a connection medium such as a USB cable. However, other methods of transferring data are available and the use of the term “USB cable” is not intended to be limiting.

For example, a USB-A connection has 4 pins. Each pin is utilized for a specific purpose, such as a supply voltage pin, a data (−) pin, a data (+) pin, and a supply voltage ground pin. Other connection units may have more than or less than 4 pins, and each pin may have different usage. In some examples, the electrical connection of the interface 114 may also permit the data storage device 106 to receive power from the host device 104. For example, as illustrated in FIG. 1, the power supply 111 may receive power from the host device 104 via the interface 114.

The data storage device 106 includes NVM 110, which may include a plurality of memory devices or memory units. NVM 110 may be configured to store and/or retrieve data. For instance, a memory unit of NVM 110 may receive data and a message from the controller 108 that instructs the memory unit to store the data. Similarly, the memory unit of NVM 110 may receive a message from the controller 108 that instructs the memory unit to retrieve data. In some examples, each of the memory units may be referred to as a die. In some examples, a single physical chip may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit of NVM 110 may include any type of non-volatile memory devices, such as flash memory devices, phase-change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices.

The NVM 110 may comprise a plurality of flash memory devices or memory units. Flash memory devices may include NAND or NOR based flash memory devices and may store data based on a charge contained in a floating gate of a transistor for each flash memory cell. In NAND flash memory devices, the flash memory device may be divided into a plurality of blocks, which may be divided into a plurality of pages. Each block of the plurality of blocks within a particular memory device may include a plurality of NAND cells. Rows of NAND cells may be electrically connected using a word line to define a page of a plurality of pages. Respective cells in each of the plurality of pages may be electrically connected to respective bit lines. Furthermore, NAND flash memory devices may be 2D or 3D devices and may be single-level cell (SLC), multi-level cell (MLC), triple-level cell (TLC), or quad-level cell (QLC). The controller 108 may write data to and read data from NAND flash memory devices at the page level and erase data from NAND flash memory devices at the block level.

The data storage device 106 includes a power supply 111, which may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via the interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, supercapacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The data storage device 106 also includes volatile memory 112, which may be used by controller 108 to store information. Volatile memory 112 may be comprised of one or more volatile memory devices. In some examples, the controller 108 may use volatile memory 112 as a cache. For instance, the controller 108 may store cached information in volatile memory 112 until cached information is written to non-volatile memory 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)).

The data storage device 106 includes a controller 108, which may manage one or more operations of the data storage device 106. For instance, the controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. The controller 108 may determine at least one operational characteristic of the storage system 100 and store the at least one operational characteristic to the NVM 110. In some embodiments, when the data storage device 106 receives a write command from the host device 104, the controller 108 temporarily stores the data associated with the write command in the internal memory before sending the data to the NVM 110.

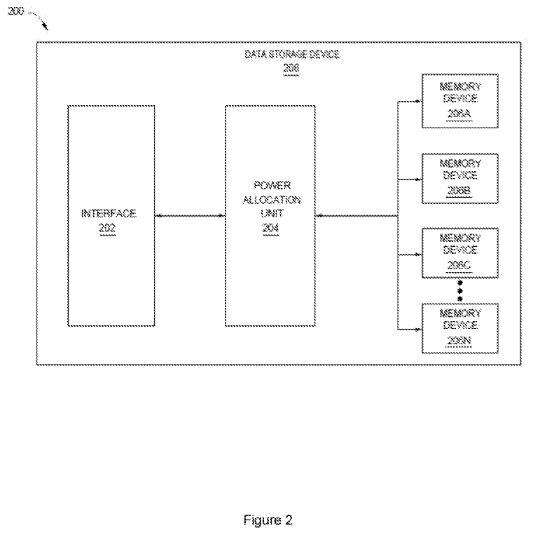

FIG. 2 is a schematic illustration of a data storage device 208, according to one embodiment. Data storage device 208 comprises an interface 202 and a power allocation unit (PAU) 204. The interface 202 may be the interface 114 of FIG. 1. The data storage device 208 further comprises an array of memory devices 206A-206N (collectively referred to as memory devices 206). The notation “N” refers to the last memory device of a plurality of memory devices. Furthermore, the memory devices 206 may be the non-volatile memory 110 of FIG. 1 or an NVMe storage device. Each of the memory devices 206A-206N may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.). However, the listed data storage size of the memory devices is not intended to be limiting nor restricting. Furthermore, in one embodiment, memory devices 206A-206N are the same type and have the same data storage sizes. In another embodiment, memory devices 206A-206N are different types but have the same data storage sizes. In yet another embodiment, memory devices 206A-206N are different types and have different data storage sizes.

The power allocation unit 204 may be coupled with a controller (not shown), such as the controller 108 of FIG. 1. The PAU 204 appropriates power received from the host device, such as the host device 104 of FIG. 1, to each of the memory devices 206. The controller 108 may determine the appropriate power state of each memory device 206A-206N, and the PAU 204 provides the corresponding power to each memory device 206A-206N.

The host device 104 may provide a suitable amount of power to the data storage device 208 through one or more pins on the interface 202. The suitable amount of power may be more than or equal to the amount of power the data storage device 208 requires to operate. For example, the power a data storage device 208 may receive from the host device 104 may be about 5 W. Furthermore, a data storage device 208 may draw out about 500 mW to about 15 W of power from the host device 104. The previously mentioned values for power are not intended to be limiting, but to provide a reference.

A memory device 206A-206N may have several power states (PS). For example, a memory device 206A-206N may have the following 5 power states: PS0, PS1, PS2, PS3, and PS4. Each of the power states is associated with a distinct data storage device 208 operation. Power states PS0, PS1, and PS2 are considered operational power states, utilizing about 1 W to about 8 W of power, whereas power states PS3 and PS4 are considered non-operational power states, utilizing about 2 mW to about 50 mW of power. An operational power state refers to the ability of a host device, such as the host device 104 of FIG. 1, to communicate with a memory device 206A-206N of a data storage device 208.

Power states are numbered sequentially, where higher numbers represent lower power requirements and corresponding higher exit latencies. Furthermore, each power state has an associated power requirement and an exit latency. PS0 may require 4.5 W with the lowest exit latency. PS1 may require less power than PS0, such as 3 W, and may have an exit latency equal to or higher than the exit latency of PS0. PS2 may require less power than PS1 and may have an exit latency equal to or higher than the exit latency of PS1. PS3 may require less power than PS2 and may have an exit latency equal to or higher than the exit latency of PS2. PS4 may require less power than PS3, such as 5 mW, and may have an exit latency equal to or higher than the exit latency of PS3, such as 50 mW. The values for the power states and exit latencies are not intended to be limiting, but to provide an example of possible embodiments.

PS0 is referred to as a fully operational state, where I/O commands are enabled, and the device may generate interrupts. Interrupts are an automatic transfer of firmware execution due to a system timer or a user command. Furthermore, power states PS1, PS2, PS3, and PS4 are considered low power states. Power states PS1 and PS2 are also operational states; however, PS1 and PS2 may have a lower functionality than that of PS0. Power states PS3 and PS4 are non-operational states that have a power requirement less than that of the operational power states. Furthermore, memory devices 206 not used are placed in a non-operational power state PS4 to limit the idle power consumption to a minimal value.

In order for I/O commands to occur, the memory device 206A-206N is woken up and placed into power state PS0. The controller, such as the controller 108 of FIG. 1, utilizes the PAU 204 to change the power state of a memory device 206A-206N from PS0 to either PS1, PS2, or PS3 dependent on the situation. However, in order for a memory device 206A-206N to be placed into PS4, the memory device 206A-206N will need to be in power state PS3. However, the controller 108 is able to utilize the PAU 204 to allocate the appropriate amount of power to place all power states PS1, PS2, PS3, and PS4 into power state PS0 when a fully operational state is required.

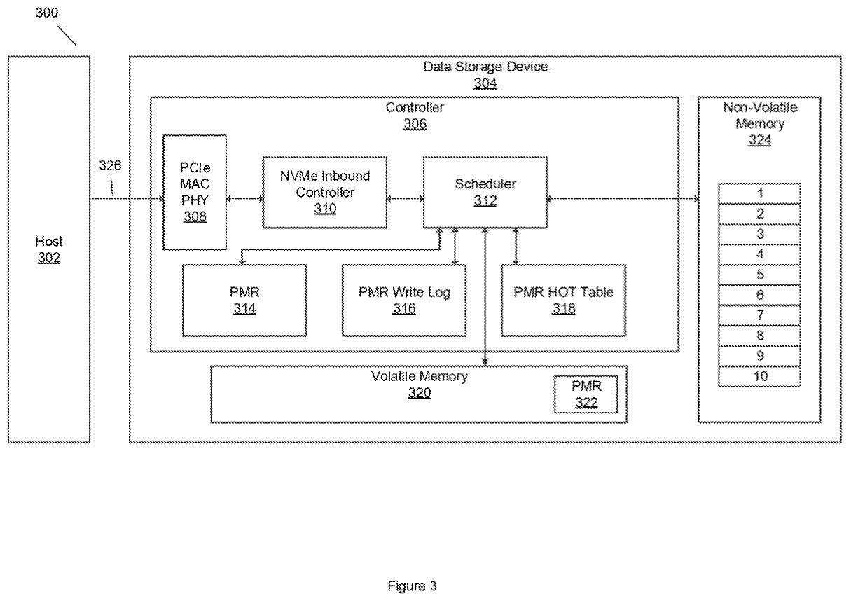

FIG. 3 is a schematic illustration of a computing system 300, including a host device 302 and a data storage device 304, according to disclosed embodiments. Aspects of the computing system 300 may be similar to the computing system 100 of FIG. 1 and/or the data storage device 200 of FIG. 2. For example, the host 302 may be similar to the host 104 of FIG. 1, and the controller 306 may be similar to controller 108 of FIG. 1.

The data storage device 304 includes a controller 306 and an NVM 324. The controller 306 includes a PCIe/MAC/PHY 308, an NVMe inbound controller 310, a scheduler 312, a first persistent memory region (PMR) 314, a PMR write log 316, a PMR HOT table 318, and a volatile memory 320. The volatile memory 320 may be DRAM or SRAM. In various embodiments, the volatile memory 320 is a non-volatile memory, MRAM, while in other embodiments this element could be an internal SRAM space inside the controller 306, a memory external to the controller 306 such as on a DRAM device, or other memory space accessible by the controller 306. The volatile memory 320 includes a second PMR 322. In various embodiments, controller 306 does not include the volatile memory 320. The NVM 324 includes an array of memory locations, where the controller 306 may access portions of the memory array to complete read and/or write commands from the host 302.

The controller 306 receives data from the host 302 via an ingress bus 326. The transferred to the controller 306 is received by the PCIe/MAC/PHY 308. After the data is encoded at the PCIe/MAC/PHY 308, the data is transferred to the NVMe inbound controller 310. The NVMe inbound controller 310 appropriates the data sent by the host 302 to the relevant section of the data storage device 304, such as in one of the memory arrays of the NVM 324 and/or the volatile memory 320. The scheduler 312 manages the traffic within controller 310. For example, if a new read or write command is received by the controller 306, the scheduler 312 may place the received read or write command in a command buffer or queue until the one or more commands being executed by the controller is completed.

The data is transferred from the scheduler 312 to the first PMR 314, the PMR write log 316, the PMR HOT table 318, the NVM 324, and/or the volatile memory 320 that includes a second PMR 322. The first PMR 314 and/or the second PMR 322 is an intermediate buffer between the host 302 and the NVM 324. In one embodiment, the host 302 writes to the first PMR 314 and/or the second PMR 322, and the storage device 304 reads from first PMR 314 and/or the second PMR 322. In another embodiment, the storage device 304 writes to the first PMR 314 and/or the second PMR 322, and the host 302 read from the first PMR 314 and/or the second PMR 322.

The PMR HOT table 318 includes a table that tracks the location of all data elements of the erase blocks or banks of the first PMR 314 or the second PMR 322. In the description herein, the data elements may be referred to as data, where data includes the data elements and the host or device data, for exemplary purposes. Each erase block or bank of the first PMR 314 or the second PMR 322 includes a bit that indicates whether the erase block or the bank is “HOT” or not. The PMR HOT table 318 tracks the bits of the first PMR 314 and/or the second PMR 322. For example, a “HOT” erase block or bank may have an associated bit of “1”, indicating that the relevant erase block or bank has a high probability of being read. The controller 306 tracks the erase blocks or banks of the first PMR 314 or the second PMR 322 as “HOT” that have been written to by the storage device 304 but has not been read by the host 304.

When the storage device 304 is powered off, the data stored in the first PMR 314 and/or the second PMR 322 is saved to the NVM 324, so that the data stored in the first PMR 314 and/or the second PMR 322 is not lost. When the storage device 304 is powered on, the first PMR 314 data and/or the second PMR 322 data stored in the NVM 324 is restored to the respective locations in the first PMR 314 and/or the second PMR 322. After the data is successfully restored to the first PMR 314 and/or the second PMR 322, the storage device 304 may set an indicator that indicates to the host 302 that the first PMR 314 and/or the second PMR 322 is ready for read or write commands. The indicator may be through the NVMe configuration registers, where a PMR status not ready (PMRSTS.NRDY) bit value of 1 corresponds to “not ready (NRDY).”

The PMR write log 316 includes a table that tracks the location of the new or updated data in the first PMR 314 and/or the second PMR 322. When the data is restored to the first PMR 314 and/or the second PMR 322 after the storage device 304 power on, the data is merged with any new data written to the PMR 314 and/or the second PMR 322.

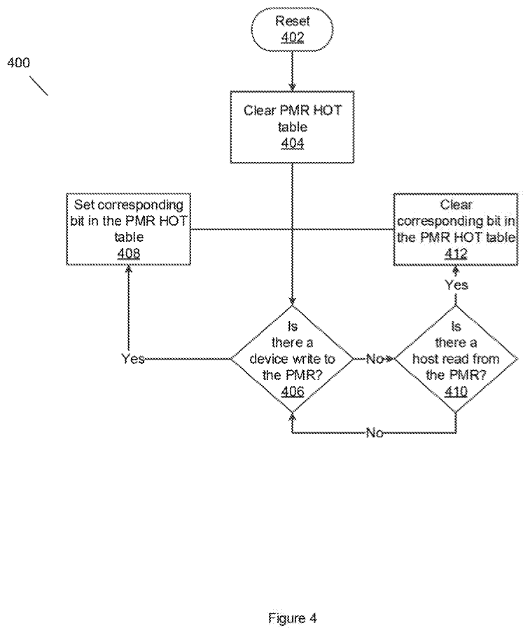

FIG. 4 is a flowchart illustrating a method 400 for utilizing the PMR HOT table, according to disclosed embodiments. Aspects of the computer system 300 of FIG. 3 may be utilized in the description of FIG. 4. At block 402, the storage device, such as the storage device 304 of FIG. 3, is reset. When the storage device is reset, the storage device undergoes a power-off event and a power-on event. The PMR write log, such as the PMR write log 316 of FIG. 3, tracks the which data has been written to the PMR while the PMR is ready, but not fully restored from the NVM. At block 404, the PMR, such as the first PMR 314 and/or the second PMR 322, is empty, and the PMR HOT table, such as the PMR HOT table 318 of FIG. 3, is cleared.

At block 406, the controller, such as controller 306 of FIG. 3, determines if there has been a device write to the PMR. If a device write has occurred to the PMR at block 406, then the corresponding bit in the PMR HOT table is set to 1, which corresponds to “HOT,” at block 408. However, if the controller determines that there has not been a device write to the PMR at block 406, then at block 410, the controller determines if there is a host, such as host 302 of FIG. 3, read from the PMR. If there has not been a host read from the PMR at block 410, then the controller waits for a device write to the PMR or a host read from the PMR to be received. However, if there has been a host read from the PMR at block 410, then the corresponding bit in the PMR HOT table is cleared at block 412. After setting the corresponding bit to “HOT” at block 408 due to a device write to the PMR and/or after clearing the corresponding bit at block 412 due to a host read to the PMR, the PMR HOT table is cleared of all data that is not “HOT.”

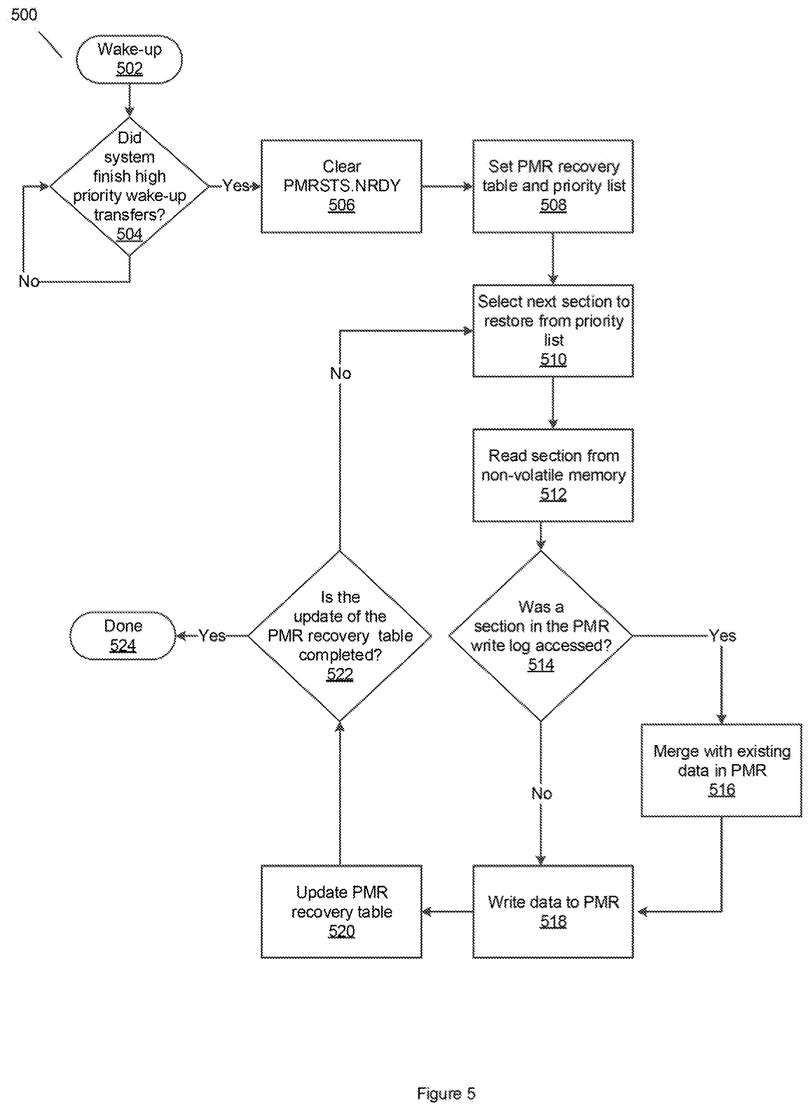

FIG. 5 is a flowchart illustrating a method 500 for the PMR restoration, according to disclosed embodiments. Aspects of the computer system 300 of FIG. 3 may be utilized in the description of FIG. 5. At block 502, the storage device, such as the storage device 304 of FIG. 3, is powered on or “woken up.” At block 504, the controller, such as controller 306 of FIG. 3, determines if the storage device has completed the high priority wake-up transfers. If the storage device has not yet completed the high priority wake-up transfers at block 504, the controller waits until the transfers are completed before clearing the PMRSTS.RDY bit at block 506. When the PMRSTS.RDY bit is cleared, the storage device indicates to the host that the PMR is ready to be utilized.

At block 508, the PMR recovery table and priority list are set. The priority list includes a table of all the erase blocks or all the banks of the PMR, where erase blocks or banks with a “HOT” indicator have the highest priority. Because none of the PMR sections have been restored, the restoration table is cleared. The restoration table tracks which sections of the PMR have been restored from the NVM. At block 510, the highest priority erase block or bank in the priority list is restored to the relevant location in the PMR. For example, a first read request for a first data element may have a higher priority than a second read request for a second data element. The priority may be set based on the timing of when the read requests were received. When the erase block or bank is restored, the relevant data is read from the NVM at block 512.

At block 514, the controller determines if a section in the PMR write log has been accessed. During the read of each section, the section is checked against the write log. If there is a hit in the PMR write log (e.g., new data has been written to the PMR for that particular section), then at block 516, the relevant data stored in the NVM is merged with the existing data in the PMR and the merged data is written to the PMR at block 518. For example, if the NVM includes data that corresponds with the new third data element, the NVM data, and the new third data element are merged. The merged third data element is then written to the PMR. However, if there is not a hit in the PMR write log, the data is written to the PMR at block 518. For example, if the first read request for the first data element has been successfully written to the PMR, the first data element is removed from the priority list.

At block 520, the PMR recovery table is updated with the corresponding bit indicating the successful restoration of the section of the data in the PMR. At block 522, the controller determines if the PMR table update has been completed. If all the existing PMR data in the NVM has not been successfully written to the PMR at block 522, then the controller selects the next highest priority section, such as the second read request for the second data element, to restore from the NVM to the PMR at block 510. When the second read request for the second data element has been successfully written to the PMR, the second data element is removed from the priority list. However, if all the existing PMR data in the NVM has been successfully written to the PMR at block 522, then the method 500 is completed at block 524.

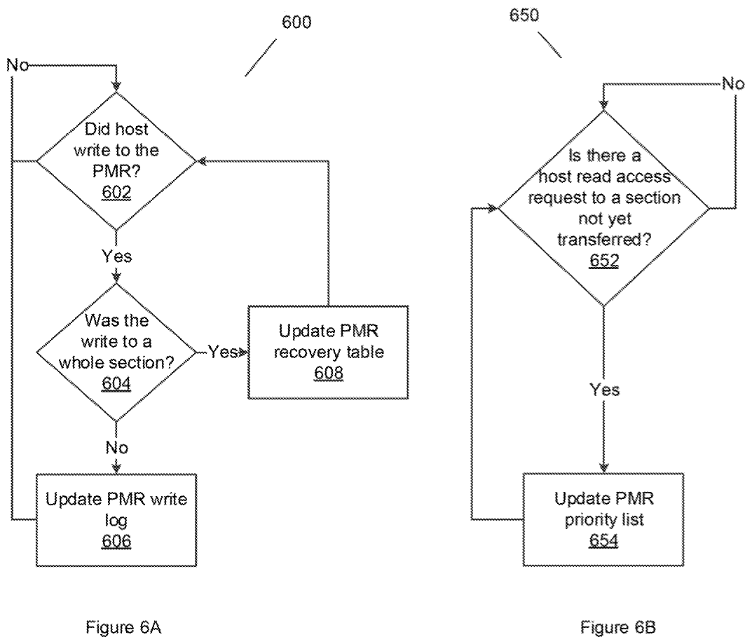

FIG. 6A is a flowchart illustrating a method 600 for monitoring the host PMR write access, according to disclosed embodiments. Aspects of the computer system 300 of FIG. 3 and the method 500 may be utilized in the description of FIG. 6A. At block 602, the controller determines if a host write to the PMR has been executed. If a host write to the PMR has been executed, then the controller determines if the host write was to an entire PMR section at block 604. If the host write was to an entire PMR section at block 604, then the PMR recovery table is updated at block 608. The PMR recovery table includes the location of each section that has been successfully updated in the PMR. The controller waits for another host write request at block 602.

However, if the write was not to an entire PMR section at block 604, then the PMR write log is updated at block 606. For example, a third write request for a third data element to partially fill a first PMR section is received by the controller. Because the write size for the third data is less than a PMR section, the controller updates the PMR write log with the third write request for a third data element. The PMR write log is utilized during the restoration process, such as in method 500 of FIG. 5, in order to merge the restored data. The controller waits for another host write request at block 602.

FIG. 6B is a flowchart illustrating a method 650 for monitoring the host PMR read access, according to disclosed embodiments. Aspects of the computer system 300 of FIG. 3 and the method 500 may be utilized in the description of FIG. 6B. At block 652, the controller determines if there is a host read access request to a section that has not been transferred yet. If there is a host read access request to a section that has not been transferred yet, then the PMR priority list is updated at block 654. However, if there is the host read access request to a section has already been transferred, then the PMR priority list need not be accessed. For example, if the host requests to read a section of the PMR that has not been restored yet, the PMR recovery priority list would be updated so that the requested section would have the highest priority and be completed next in the queue.

By including a log of PMR writes, the data storage device may have a faster dynamic recovery of the PMR. The log of PMR writes includes a priority table, which may allow for the controller to service the PMR requests with a high priority while the storage device is undergoing wake-up operations instead of waiting for the PMR to be fully recovered. The storage device may indicate to the host that the PMR is ready, such that the host may begin to send write requests to the PMR. By shortening the time to indicate that the PMR is ready, the wake-up time of the data storage device may be shortened.

In one embodiment, a data storage device is provided that includes one or more memory devices, and a controller comprising a persistent memory region (PMR) comprising one or more blocks, and a PMR HOT table and coupled to the one or more memory devices. In embodiments, the controller is configured to detect a write to a block of the PMR by the data storage device, and store a high priority indicator for the block of the PMR in the PMR HOT table.

The controller is further configured to cause the data storage device to enter into a low power state, set a PMRSTS.NRDY bit, and clear the PMR. The controller is further configured to cause the storage device to exit the low power state, and detect the high priority indicator in the PMR hot table. The controller is further configured to cause the block to be restored to the PMR. The controller is further configured to clear the PMRSTS.NRDY bit. The controller is further configured to detect a host read to a second block of the PMR from the host, where the second block has not been restored. The second block is added to the PMR hot table. The controller is further configured to clear the high priority indicator upon detecting a read by a host of the block.

In another embodiment, a data storage device is provided that includes one or more memory devices, a non-volatile memory coupled to the PMR for storing data from the PMR when the data storage device is in a low power mode, and a controller comprising a persistent memor region (PMR) comprising one or more blocks, a PMR write log, the controller coupled to the one or more memory devices. In embodiments, the controller is configured to cause the data storage device to exit a low power mode, read data from the non-volatile memory, and cause data written from a host to be stored in the PMR write log before the data storage device is in a powered state.

The controller is further configured to determine if data written from the host corresponds with data on the non-volatile memory. The controller is further configured to merge the data written from the host when it corresponds with data on the non-volatile memory and writing the merged data to the PMR. The controller is further configured to write the data from the non-volatile memory to the PMR if it is determined that the data written from the host does not correspond with data from the non-volatile memory.

In another embodiment, a system for storing data is provided, that includes one or more memory devices comprising a non-volatile memory device, and a controller comprising a PMR means, a write log means, a HOT table means configured to store an indicator that the system has written a data element to the PMR means and a host has not read the data element from the PMR means, and a PMRSTS.NRDY bit indicating that the PMR means is not ready, the controller coupled to the one or more memory devices. In embodiments, the controller is configured to cause the system to exit a low power state, and read the indicator from the HOT table means.

The controller is further configured to cause the data element to be written to the PMR. The controller is further configured to clear the PMRSTS.NRDY bit, indicating that the PMR is ready. The system includes a priority list, where the controller is further configured to determine that the host has made a read request of the PMR for a second data element, and updated the priority list to include the second data element. The controller is configured to restore the second data element to the PMR from the non-volatile memory, and remove the second data element from the priority list. The controller is further configured to receive a write of a third data element from the host and update the write log means to include the third data element. The controller is further configured to perform one of a merge with existing data in the non-volatile memory with the third data element and writing the merged data to the PMR, and writing the third data element to the PMR. The controller is further configured to complete exit from the low power state upon writing either the merged data or third data element to the PMR.

While the foregoing is directed to embodiments of the present disclosure, other and further embodiments of the disclosure may be devised without departing from the basic scope thereof, and the scope thereof is determined by the claims that follow.

What is claimed is:

1. A data storage device comprising:
one or more memory devices; and
a controller comprising a persistent memory region (PMR) comprising one or more blocks, and a PMR HOT table and coupled to the one or more memory devices, wherein the controller is configured to:
detect a write to a block of the PMR by the data storage device; and
store a high priority indicator for the block of the PMR in the PMR HOT table.

2. The data storage device of claim 1, wherein the controller is further configured to cause the data storage device to enter into a low power state, set a PMRSTS.NRDY bit, and clear the PMR.

3. The data storage device of claim 2, wherein the controller is further configured to cause the storage device to exit the low power state, and detect the high priority indicator in the PMR HOT table.

4. The data storage device of claim 3, wherein the controller is further configured to cause the block to be restored to the PMR.

5. The data storage device of claim 4, wherein the controller is further configured to clear the PMRSTS.NRDY bit.

6. The data storage device of claim 5, wherein the controller is further configured to detect a host read to a second block of the PMR from the host, wherein the second block has not been restored.

7. The data storage device of claim 6, wherein the second block is added to a PMR priority list.

8. The data storage device of claim 4, wherein the controller is further configured to clear the high priority indicator upon detecting a read by a host of the block.

9. A data storage device, comprising:
one or more memory devices;
a non-volatile memory coupled to the PMR for storing data from the PMR when the data storage device is in a low power mode; and
a controller comprising a persistent memory region (PMR) comprising one or more blocks, a PMR write log, the controller coupled to the one or more memory devices, wherein the controller is configured to:
cause the data storage device to exit a low power mode;
read data from the non-volatile memory; and
cause data written from a host to be stored in the PMR write log before the data storage device is in a powered state.

10. The data storage device of claim 9, wherein the controller is further configured to determine if an address of data written from the host corresponds with an address of data on the non-volatile memory.

11. The data storage device of claim 10, wherein the controller is further configured to merge the data written from the host when the address of data written from the host corresponds with the address of data on the non-volatile memory, and writing the merged data to the PMR.

12. The data storage device of claim 11, wherein the controller is further configured to write the data from the non-volatile memory to the PMR if it is determined that the data written from the host does not correspond with data from the non-volatile memory.

13. A system for storing data, comprising:
one or more memory devices comprising a non-volatile memory device; and
a controller comprising a PMR means, a write log means, a HOT table means configured to store an indicator that the system has written a data element to the PMR means and a host has not read the data element from the PMR means, a PMRSTS.NRDY bit indicating that the PMR means is not ready, the controller coupled to the one or more memory devices, the controller configured to:
cause the system to exit a low power state; and
read the indicator from the HOT table means.

14. The system of claim 13, wherein the controller is further configured to cause the data element to be written to the PMR means.

15. The system of claim 14, wherein the controller is further configured to clear the PMRSTS.NRDY bit, indicating that the PMR means is ready.

16. The system of claim 15, further comprising a priority list, wherein the controller is further configured to determine that the host has made a read request of the PMR for a second data element, and updated the priority list to include the second data element.

17. The system of claim 16, wherein the controller is configured to restore the second data element to the PMR from the non-volatile memory device of the one or more memory devices.

18. The system of claim 15, wherein the controller is further configured to receive a write of a third data element from the host and update the write log means to include the third data element.

19. The system of claim 18, wherein the controller is further configured to perform one of a merge with existing data in the non-volatile memory with the third data element and writing the merged data to the PMR means, and writing the third data element to the PMR means.

20. The system of claim 19, wherein the controller is further configured to complete exit from the low power state upon writing either the merged data or third data element to the PMR means.
